(19) United States
(12) Patent Application Publication
(10) Pub. No.: US 2023/0222198 A1
(43) Pub. Date: Jul. 13, 2023

(54) System and method for validating the identity of a user seeking access to a protected account or physical places by requiring a sequenced selection of colors from one or more palettes or panels of colors visually presented to the user seeking access

(71) Applicants: Gary William Streuter, Laguna Niguel, CA (US); William Pat Price, Henderson, NV (US)

(72) Inventors: Gary William Streuter, Laguna Niguel, CA (US); William Pat Price, Henderson, NV (US)

(21) Appl. No.: 18/151,443

(22) Filed: Jan. 8, 2023

Related U.S. Application Data
(60) Provisional application No. 63/266,595, filed on Jan. 10, 2022.

(51) Int. Cl. G06F 21/36

(52) U.S. Cl. CPC G06F 21/36

(57) ABSTRACT

A system and method for confirming the identity of a user seeking access to a protected account or physical place by using the sequenced selection of one or more colors from one or more panels and/or palettes of color that are presented visually to the user seeking access. An identification key is built based on the hidden unique identifiers assigned for each said color selected by the user and the sequence in which the colors were selected by the user. Each color displayed has an assigned unique identifier that is not visible to the user seeking access but is used by a first software programing operating on the uses device to assemble the identification key required to gain account access.

### FIELD OF INVENTION

The field of invention relates to validation of the identity of a user seeking access to protected online accounts or websites, as well as access to physical places and devices.

### BACKGROUND

In our modern world, the issue of account and data security has risen to new heights of awareness and concern. This can range from the security of our financial and personal data to even issues of physical security. The concept of right to enter and authorized account access are under siege from relatively new innovations that have been spawned from the Internet and that have made so much information available to anyone with just the press of a button. Want to know something—just Google it!

It has long been known that people are the weakest link in any security architecture, and digital account access is no different. The need for a password challenge to validate account entry authorization has created many different scenarios whereby the user is asked to create what may be considered a strong, complex password (large number of numbers/letters/symbols or characters). While these long, complex passwords are certainly more difficult to hack, they tend to push users into behaviors that can defeat the good intention of these long and complex behaviors.

Some of the most common negative behavior adopted by account users include the following:
They write the password down so they can access it when needed—numerous studies have found large numbers of passwords written on post-it notes and attached to monitors.
They will use the same password over, from account to account—increasing the likelihood that a breach of their credentials from one account will yield a breach to others sharing that password.
They hesitate to change their password on a timely basis—reluctant to try to remember a new password.
They share their password with others, creating a direct breach opportunity.

The three most popular methods of digital account validation are as follows:
1. Something you ARE: a biometric identifier tied to the rightful account owner.
2. Something you HAVE: referring to an external physical device that must be available to achieve account access. Examples of this are USB memory sticks, tokens, or a specific digital device such as a computer or smartphone.
3. Something you KNOW: This is your typical password, passphrase, or two-factor code.

The identification technology described in this disclosure is based on the 3^{rd} method above—Something that you KNOW. That something is made up of a sequenced selection of colors from one or more panels or palettes of color(s) and that sequenced selection must be duplicated when seeking access to a protected account. Our intention with this technology is to offer a visual method of identification validation that will present additional challenges to bad actors seeking to compromise account access.

### SUMMARY OF THE INVENTION

The identification technology described in this disclosure is a method whereby the rightful account owner, during an account registration, update or account access process, selects in sequence, one or more colors from an array of one or more panels or palettes of color(s) presented visually to the user. The initiation of the identification process resembles the typical steps used to select a password during the account registration process. The user seeking access is visually presented with one or more palettes containing one or more colors. The user is asked to select, in sequence, one or more colors from one or more of the palettes displayed. The user may be asked to confirm this color selection and the sequence in which the color(s) were selected one or more additional times, much as is done today when a password entry process requires that the user again input the password characters selected in a confirmation process.

Each color selection displayed to the user within a palette has a uniquely assigned identifier representing that specific color within a specific palette(s). Said unique assigned identifier may be variable from installation to installation and is hidden from view and not visible to said user during the account registration or access process. Based on the sequence in which the colors were selected, said unique assigned identifier representing each sequenced color choice selected are assembled in the color sequence in which they were selected during the registration process and this assembly of selected color identifiers becomes the identification key, which is used in the validation of the identity of the user seeking account or physical access. Thus, the created identification key consists of the sequenced identifiers corresponding to the sequenced color selections made by the user during the access registration process. This sequenced identification key is required to achieve successful access to said protected account or physical access and said identification key must be correctly reconstructed to permit successful account access.

The identity validation method can act as a standalone replacement for a typical “Know” form of identification validation, such as passwords and/or two-factor identification. Said identity method may also be configured as a second-factor identifier when used with other forms of identification verification such as, but not limited to, passwords, bio-metric recognition, two-factor OTA codes, tokens, or other external forms of identification validation such as USB keys etc.

Once the identification key has been created and the rightful account owners protected account or physical location has been provisioned to accept said identification key, the following procedure is used by the rightful account owner to gain access to their protected accounts:
1. The rightful account owner seeks access to the protected account or location they wish to enter, whereby the identification method described in this specification is the primary form of account access validation.
2. The protected account displays the color panels or palettes associated with the account being accessed.
3. The rightful account owner is then asked to select the correct colors from the color panels and/or palettes in the same sequence as selected during the registration process.
4. The rightful account holder enters their color selections in sequence and launches an access request to said protected account or physical location.
5. Said protected account receives said colors based unique identifiers and sequence inputs and translates the unique assigned color code identifiers into an identification key.
6. Said protected account then seeks to confirm a match of the identification key submitted against its database of identification keys assigned to said rightful account owner's account or physical location.
7. If said identification key matches the registered identification key assigned to said protected account matches, account access is then granted.
8. If the protected account cannot match said submitted identification key to the registered identification key assigned to said protected account or physical location, the access request is denied.

In the identification key system and method described in this disclosure, the database of created identification keys is stored, maintained, and matched within an online digital database associated with the protected account. In an alternative embodiment, the database of identification keys may also be stored, maintained, and matched within the computer, tablet or smartphone being used to seek access to the protected account, or within a physical storage device that may be connected to said computer, tablet or smartphone.

### Problem Statement

Traditional password systems rely on a string of numbers, characters or symbols that are known to the user. It is also understood that users are typically the weakest link in the security chain. Thus, the potential for the user to expose their password, or the potential of a hacker to monitor the input patterns of the user during the password process represents a major flaw in maintaining account security. It is also well known that humans are very visual. As the old saying goes “A picture is worth a thousand words”. The concept described in this specification takes advantage of this human trait in enabling them to use this to their advantage in providing for secure access.

### Dictionary

System: A system and method by which a user seeking access to an account or physical location selects, from one or more colors displayed visually to said user in one or more palettes in a selection sequence remembered by the user and said selection sequence is incorporated into the building of the identification key.
Identification Key: A user selects in sequence from color panels visually displayed. Each color selected has a unique code assigned to said color panel and the first software program assembles said identification key by grouping the codes assigned to each color panel in the sequence in which they were selected—thus creating an identification code that must be matched for future account or physical access.
Color: Color is the aspect of things that is caused by differing qualities of light being reflected or emitted by them. To see color, you must have light. When light shines on an object some colors bounce off the object and others are absorbed by it. Our eyes only see the colors that are bounced off or reflected by the object.
Color Palette: A color palette refers to collections of color panels that are grouped and presented to the user and can be displayed on a device screen or other interface.
Color Panel: Individual color representation displayed to the user on a device screen or other interface.
Shades of Color: Color selections presented to the user may be various shades of a base color.
In Sequence: Following the same order of selection.

### BRIEF DESCRIPTION OF THE DRAWINGS

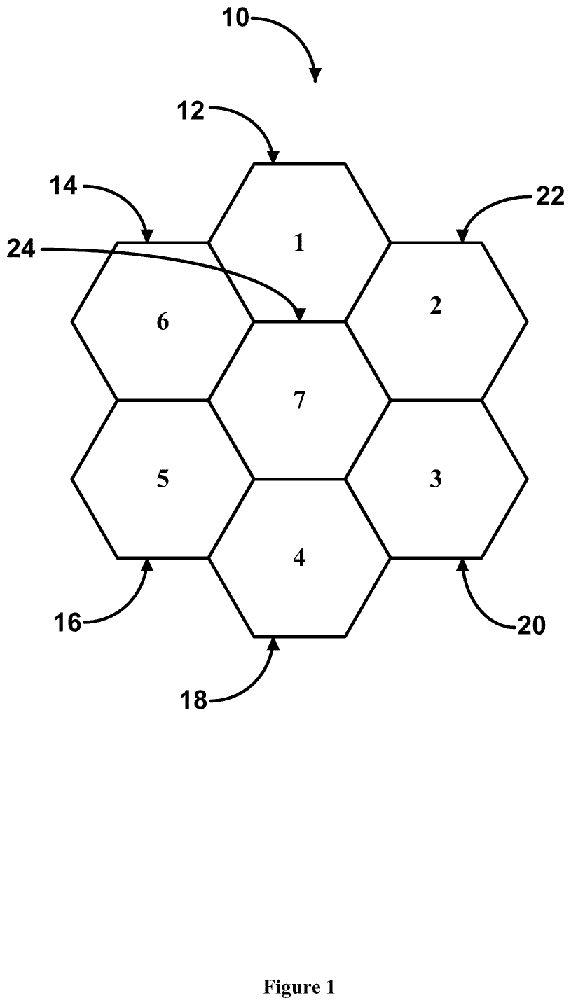

1. FIG. 1 depicts a basic color palette composed of seven color panels aligned around a hexagon making up the a color palette. Note that color panels and the seven basic color palettes are shown in black and white due to figures shown in a patent are only shown in black and white.

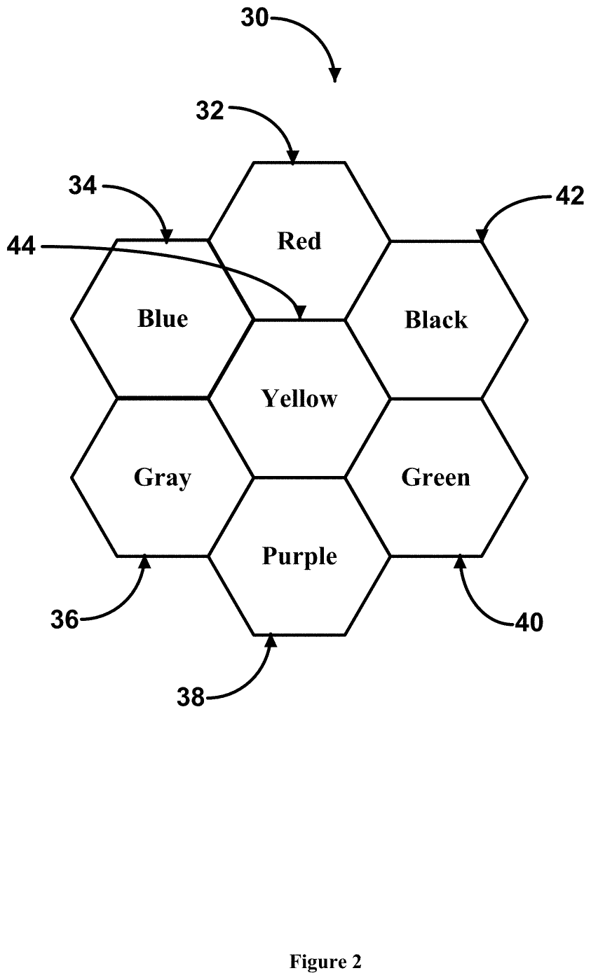

2. FIG. 2 depicts a basic color palette where the color of color panel making up a color palette is identified in English text.

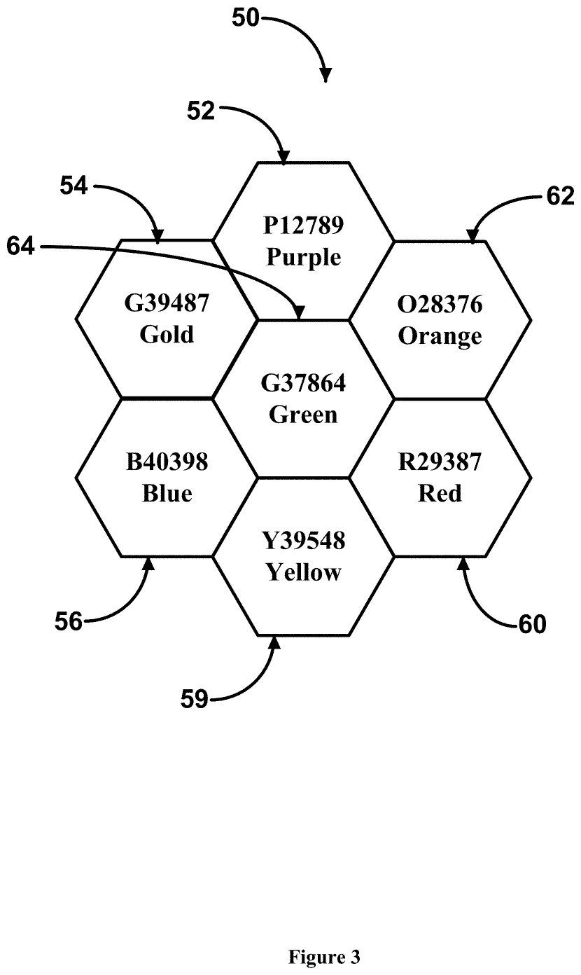

3. FIG. 3 depicts a basic color palette where the color of each color panel making up a color palette and ID of each color panel is identified in English text.

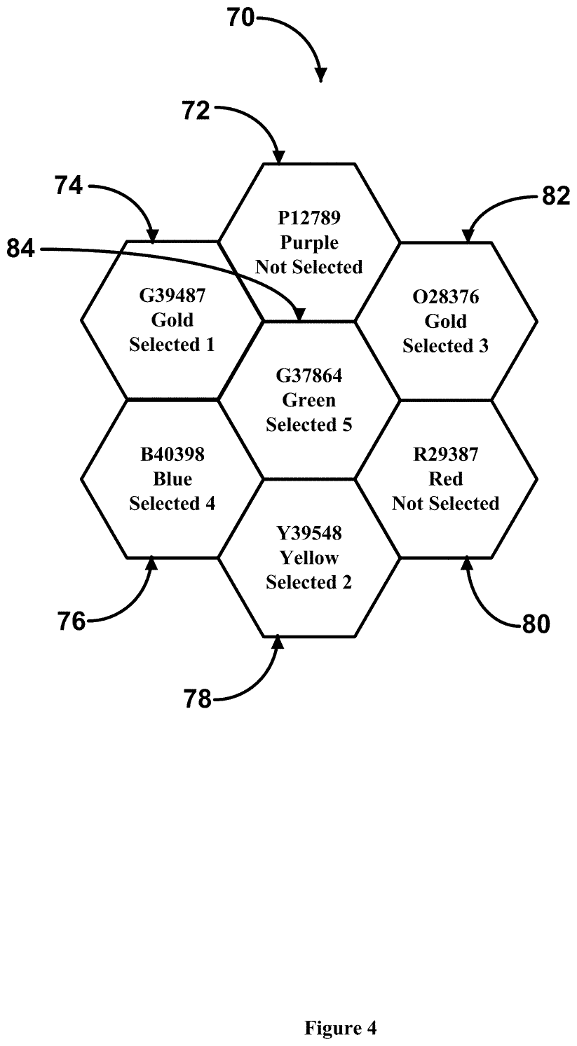

4. FIG. 4 depicts a basic color palette where three specific variables identify the features of each color panel making up the color palette. The features are composed of a specific color (example: Purple, Gold, Blue, etc) and ID of the specific each color of each color panel (example: P12789, G39487, etc) and a selection variable showing if a given color panel within a seven color palette has been selected or not selected by the user (example: Selected/Not Selected) and if selected, the sequence of the color panel's selection number (example: selected 1, selected 2, etc) for the color panel is identified in English text.

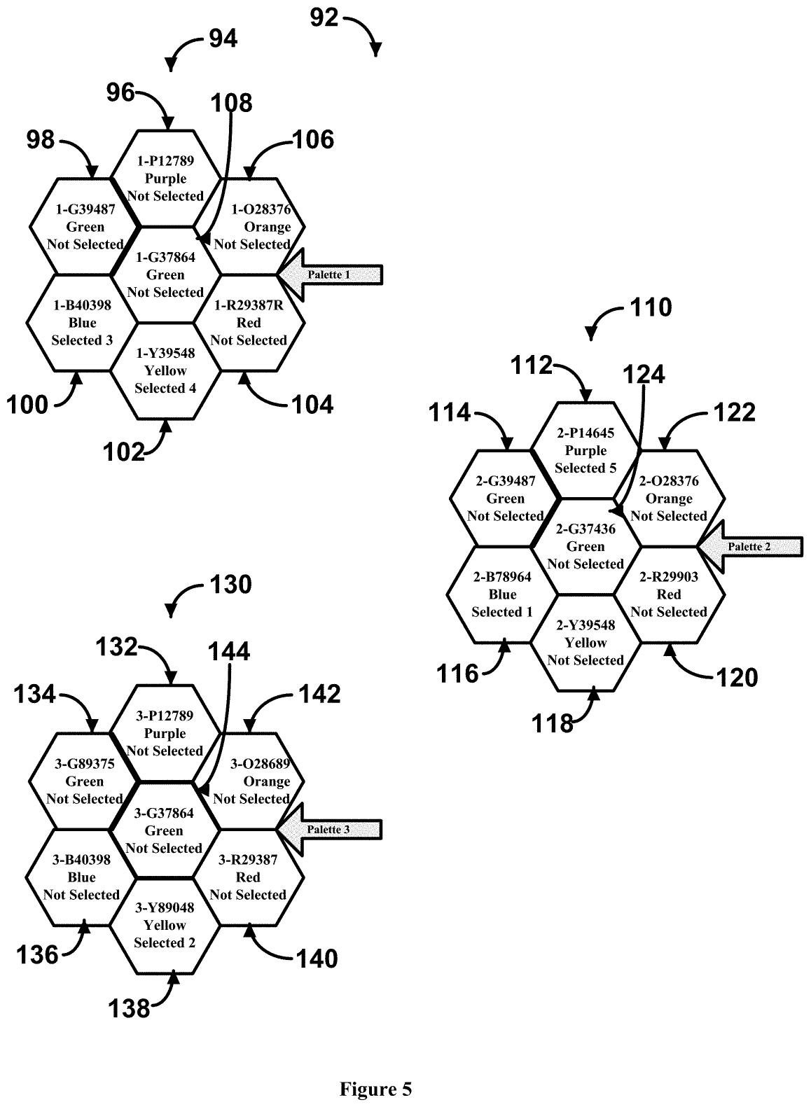

5. FIG. 5 depicts three color palettes with any given palette comprising seven color panels where the color palettes are based on figure the color palette of FIG. 4.

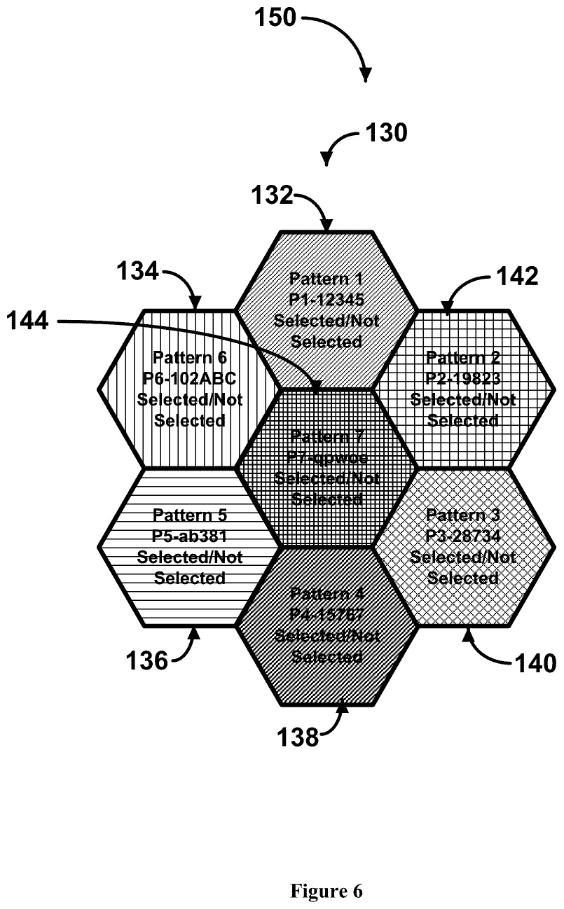

6. FIG. 6 depicts a given color palette with seven color panels where each color panel contains a background pattern instead of a background color as shown in FIGS. 1-5. This allows a color palette to be composed of color panels of either colors or patterns thus increasing the randomness of the panels.

### DETAILED DESCRIPTION

### Embodiments

In a first exemplary embodiment, one or more color palette(s) is displayed in the browser on a computing device. The color palette is composed of one or more unique colors where each unique color may be displayed as an object, such as a square, circle, triangle, hexagon, octagon or other geometric figure.

Each unique color is assigned a unique identification value. That identification value is hidden from the view of said user. During registration or account access attempts, the user will be prompted to select one or a plurality of color objects from one or a plurality of color palettes and the sequence of these selections becomes the basis of the identification key. When the user selects a color object within a color palette, the identification value of the color object and the selection sequence will be saved. Increasing the number of selected color objects included within the construction of the identification key increases the difficulty level for bad actors seeking unauthorized access to a protected account or physical location.

In a second exemplary embodiment, the sequenced selection of the one to a plurality of color objects may be used in place of the user entering a typical password.

In a third exemplary embodiment, each color displayed to the user seeking access is represented by unique assigned identifier which represents that specific shade of color and may also contain an identifier, not visible to the user, which defines a specific palette in which said color is displayed visually to the user.

In a fourth exemplary embodiment, the identification key may be used as a primary method of account or physical access validation or may in fact be combined with other forms of account access authorization in a multi-factor account access authorization system.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, display port, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory-based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification. Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein. Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A method where a first software program executing on a user's computing device requests said user to select, in sequence a plurality of color images presented visually to said user and said users color image selection and sequence of selection of each color image is used in the validation of the identity and authorization of said user to gain access, said validation of the identity and authorization comprising:
a. launching of said first software program and setting said first software program into execution on said user's device, and
b. presenting to said user a plurality of color images with each color image assigned a unique digital identifier not visible to the user, and
c. said first software program collects said unique digital identifier assigned to the color selection made by said user, and
d. said first software program builds an identification key by assembling the unique digital identifiers assigned to each color selected by said user, in the sequence in which the colors were selected, and
e. said identification key is forwarded by said first software program to be matched against an online database comprised of identification keys created during the device registration process, and
f. Account access is allowed or denied based on the positive match of the identification key created by said first software program to an entry previously submitted and maintained within the online database.

2. A method where each color panel presented to a user by a first software program, is displayed individually or grouped in a plurality of color pallets, said grouping comprising:
a. each color panel is presented to said user can be presented to said user as a free-standing color panel, or included within a color palette, and
b. individual or grouped color panel may be duplicated and displayed to said user multiple times for selection, and
c. said first software program displays a minimum plurality of two-color panels visible to said user requesting access to a user's account.

3. A method where a first software program executing on a user's first computing device during a registration process, gathers unique digital identifiers assigned to each color panel selected by the user and assembles an identification key based on the sequence of color selections made by the user and the unique digital identifiers assigned to said color selections, said unique digital identifiers and said color panel selections comprising:
a. during said registration process, said first software program assembles said identification key and submits said identification key to a cloud-based database, and
b. during said registration process, said first software program, assembles said identification key and submits said identification key to a database stored on a local storage media.
